(19) United States
(12) Patent Application Publication
(10) Pub. No.: US 2008/0144473 A1
(43) Pub. Date: Jun. 19, 2008

(54) OPTICAL ELEMENT AND OPTICAL INFORMATION RECORDING/REPRODUCING APPARATUS

(75) Inventor: Yasuaki Morimoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/019,385

(22) Filed: Jan. 24, 2008

Related U.S. Application Data
(63) Continuation of application No. PCT/JP2005/014774, filed on Aug. 11, 2005.

(51) Int. Cl. G11B 7/135

(52) U.S. Cl. 369/112.02

(57) ABSTRACT

An optical element is for generating recording signal light and reference light interferes with the recording signal light by changing an orientation state of a liquid crystal to record optical information on a recording medium through volumetric recording. The optical element includes a first polarizing element; a second polarizing element; and a liquid crystal layer that is arranged between the first polarizing layer and the second polarizing layer. An extinction angle of less than 90 degrees is formed by a light transmission axis of the first polarizing element and a light transmission axis of the second polarizing element.

### BACKGROUND OF THE INVENTION

1. Field of the Invention

The present invention relates to an optical element that generates, for recording optical information on a recording medium through volumetric recording, light with which the recording medium is to be exposed, that is, recording signal light including predetermined information and reference light for interfering with the recording signal light by changing an orientation state of a liquid crystal, and an optical information recording/reproducing apparatus that recording the optical information on the recording medium through the volumetric recording and reproduces the optical information from the recording medium. More specifically, it relates to an optical element and an optical information recording/reproducing apparatus that can obtain a stable control over intensity levels of the recording signal light and the reference light thereby improving a response speed for generating the recording signal light and the reference light and reducing manufacture costs for the optical information recording/reproducing apparatus.

2. Description of the Related Art

In recent years, an optical information recording and reproducing technology for recording optical information on a recording medium using a hologram through volumetric recording and reproducing the recorded optical information has been developed. In this optical information recording and reproducing technology, a light beam emitted from a laser beam source is divided into two light beams by amplitude division or wave surface division. One light beams is subjected to light intensity modulation or light phase modulation by a spatial light modulation element to generate recording signal light including information desired to be recorded. The other light beam is used as reference light.

During recording of information, the two light beams interlace or the two light beams are narrowed down using a convergent lens on a coaxial optical path. An interference pattern generated by an interference effect due to diffraction of the two light beams near a focus of the light beams on the recording medium is recorded on the recording medium as optical information. During reproduction of information, the recording medium is irradiated with the reference light, and the interference pattern is read, whereby the information being reproduced.

However, there is a disadvantage that, when the light beam emitted from the laser beam source is divided into the two light beams, it is difficult to reduce a size of an apparatus because it is necessary to prepare independent optical systems for the two light beams, respectively, and, when the apparatus is vibrated, optical axes of the two light beams shift and stability of information recording and reproduction falls.

To solve such a problem, there has been developed an apparatus in which recording signal light and reference light are generated through a spatial light modulator having a specific area for the recording signal light and the other area for the reference light when both areas are irradiated with a laser beam. The recording signal light and the reference light are subject to the Fourier transform through a single imaging optical system to record information on the recording medium, thereby reducing the size of the overall apparatus (for example, see Japanese Patent Application Laid-open No. 11-237829).

However, in the optical recording method, because the spatial light modulator is divided into the area for generating the recording signal light and the area for generating the reference light, it is difficult to ensure an area enough to generate the recording signal light, which causes difficulty in improving recording density.

Therefore, there has been disclosed an optical information recording/reproducing apparatus that causes a single light beam to be transmitted through a spatial-light-intensity modulation element that is formed with a plurality of divided segments each of which can vary its transmittance to generate, by changing the light beam transmittance of each segment according to information to be recorded on a recording medium, recording signal light including the information to be recorded and reference light for interfering with the recording signal light (for example, see description disclosed in International Application No. PCT/JP2005/011756).

Specifically, a spatial-light-intensity modulation element that is formed with TN (Twisted Nematic) type liquid crystal cells is divided into a plurality of matrix segments, and voltage applied on each segment is controlled. By changing the light beam transmittance of each segment, intensity modulation is performed to cause the light beam to have two intensity levels. A part of the light beam having one intensity level becomes the recording signal light, and the other part of the light beam having the other intensity level becomes the reference light.

The recording signal light and the reference light generated in this manner converge on a recording layer made of a photopolymer using an objective lens. Thereby, the recording signal light and the reference light are diffracted and interfered with each other in a three-dimensional area in the recording layer near a focus of the objective lens, and then information is recorded on the recording layer.

However, for later described reasons, the above-described conventional technology, in which the spatial-light-intensity modulation element is formed with the typical TN-type liquid crystal cell, has difficulty in controlling for generating the recording signal light and the reference light.

FIG. 18 is a diagram for explaining a relation between an extinction angle of polarizing plates forming the typical TN-type liquid crystal cell and an optical rotation angle of the liquid crystal in the conventional spatial-light-intensity modulation element. A typical TN-type liquid crystal cell has the structure in which a liquid crystal layer is arranged between two polarizing plates that are arranged in such a manner that light transmission axes are orthogonal to each other.

The extinction angle that is an angle formed by the transmission axes of the two polarizing plates and the optical rotation angle that is an angle through which light rotates due to the optical activity of the spiral-structured liquid crystal are explained with reference to FIG. 18. In the typical TN-type liquid crystal cell, the extinction angle agrees with the optical rotation angle at 90 degrees.

In a state of no voltage is applied on the liquid crystal, a vibration direction of light rotates by an amount of the optical rotation angle due to presence of the liquid crystal thereby agreeing with the extinction angle so that the light transmittance becomes one (1). When a voltage is applied on the liquid crystal layer, the liquid crystal molecule aligns to a direction orthogonal to the polarizing plates so that the optical activity disappears and the light transmittance becomes zero (0).

In actual cases, the light transmittance cannot be 1 even in the case the voltage is applied to the liquid crystal because a portion of the light is absorbed into the two polarizing plates or reflected by interfaces of the two polarizing plates. The transmittance is decided to indicate 1 when excluding such light losses.

FIG. 19 is a diagram for explaining a relation between the transmittance of the light transmitted through the liquid crystal cell and the voltage applied on the liquid crystal cell in the conventional spatial-light-intensity modulation element. As shown in FIG. 19, the transmittance, which indicates 1 in the case of no voltage is applied, decreases to 0 finally as the applied voltage increases.

In actual cases, the light transmittance cannot be 1 even in the case of no voltage is applied because the light is slightly reflected by the interfaces of the two polarizing plates. The light transmittance is evaluated by excluding light losses due to reflection.

To set an intensity-level ratio between the recording signal light and the reference light to approximately 2:1 (modulated amplitude of the recording signal light substantially agrees with the intensity level of the reference light) using the above-described typical TN-type liquid crystal cell as the spatial-light-intensity modulation element, it is necessary to set at least one of the transmittance levels of the recording signal light and the reference light in an area the transmittance varies steeply.

Therefore, when the voltage applied on the spatial-light-intensity modulation element fluctuates or response characteristic of the spatial-light-intensity modulation against the applied voltage is not homogeneous, transmittance levels of the recording signal light or the reference light fluctuates in a large range. As a result, it is difficult to properly control the intensity-level ratio between the recording signal light and the reference light, which lowers the response speed for generating the recording signal light and the reference light.

Moreover, the recording signal light and the reference light that are generated by the TN-type liquid crystal cell as the spatial-light-intensity modulation have a different optical phase. To correct the difference, it is required to provide an optical-phase correction element in addition to the spatial-light-intensity modulation element, which increases the number of parts of the optical information recording/reproducing apparatus and makes the assembly process and the inspection process of the optical information recording/reproducing apparatus complicated thereby raising the manufacture costs for the optical information recording/reproducing apparatus.

There is a need for developing a spatial-light-intensity modulation that obtains a stable control over the intensity levels of the recording signal light and the reference light, improves the response speed for generating the recording signal light and the reference light, and allows reducing manufacture costs for an optical information recording/reproducing apparatus.

### SUMMARY OF THE INVENTION

It is an object of the present invention to at least partially solve the problems in the conventional technology.

According to an aspect of the present invention, an optical element is for generating recording signal light and reference light by changing an orientation state of a liquid crystal to record optical information on a recording medium through volumetric recording, the recording signal light being emitted to the recording medium and including predetermined information, the reference light interfering with the recording signal light. The optical element includes a first polarizing element; a second polarizing element; and a liquid crystal layer that is arranged between the first polarizing layer and the second polarizing layer, wherein an extinction angle of less than 90 degrees is formed by a light transmission axis of the first polarizing element and a light transmission axis of the second polarizing element.

According to another aspect of the present invention, an optical element is for generating recording signal light and reference light by changing an orientation state of a liquid crystal to record optical information on a recording medium through volumetric recording, the recording signal light being emitted to the recording medium and including predetermined information, the reference light interfering with the recording signal light. The optical element includes a liquid crystal layer whose liquid crystal is applied with no voltage or a saturation voltage at which a light transmittance is saturated, to change the orientation state of the liquid crystal and thus to generate the recording signal light and the reference light each having a predetermined light-intensity ratio.

According to still another aspect of the present invention, an optical information recording/reproducing apparatus is for recording optical information on a recording medium through volumetric recording and reproducing the optical information from the recording medium. The optical information recording/reproducing apparatus includes an optical element in which a liquid crystal is applied with no voltage or a saturation voltage at which a light transmittance is saturated to change the orientation state of the liquid crystal and thus to generate the recording signal light and the reference light each having a predetermined light-intensity ratio.

According to still another aspect of the present invention, an optical information recording/reproducing apparatus is for recording optical information on a recording medium through volumetric recording and reproducing the optical information from the recording medium. The optical information recording/reproducing apparatus includes an optical element in which an extinction angle, which is formed by a light transmission axis of a first polarizing element and a light transmission axis of a second polarizing element the first and the second polarizing elements being opposed to each other across a liquid crystal layer, is set to an angle less than 90 degrees.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining features of a spatial-light-intensity modulation element according to a first embodiment;

FIG. 2 is a diagram for explaining a relation between light transmittance and voltage applied on the liquid crystal in the spatial-light-intensity modulation element according to the first embodiment;

FIG. 3 is a diagram for explaining a relation between the light transmittance and extinction angle;

FIG. 4 is a diagram for explaining the structure of an optical information recording/reproducing apparatus according to the first embodiment;

FIG. 5 is a diagram for explaining a spatial light modulation element 19 shown in FIG. 4;

FIG. 6 is a diagram for explaining a modulated state of a light beam passing through a plurality of segments of the spatial light modulation element 19 shown in FIG. 5;

FIG. 7 is a diagram for explaining a principle of an optical information recording process according to the first embodiment;

FIG. 8 is a diagram for explaining the structure of a spatial light modulation element 17;

FIG. 9 is a diagram for explaining the structure of an optical-phase correction element 18;

FIG. 10A is a diagram of a state of liquid crystal molecules at the time when the optical-phase correction element 18 is in an OFF state;

FIG. 10B is a diagram of a state of the liquid crystal molecules at the time when the optical-phase correction element 18 is in an ON state;

FIG. 11 is a diagram for explaining features of the spatial-light-intensity modulation element 17 according to a second embodiment;

FIG. 12 is a diagram for explaining a relation between light transmittance and voltage applied on a liquid crystal in the spatial-light-intensity modulation element 17 according to the second embodiment;

FIG. 13 is a diagram for explaining features of the spatial-light-intensity modulation element 17 according to a third embodiment;

FIG. 14 is a diagram for explaining a relation between light transmittance and voltage applied on a liquid crystal in the spatial-light-intensity modulation element 17 according to the third embodiment;

FIG. 15 is a diagram for explaining anisotropy in the refractive index of a liquid crystal molecule;

FIG. 16 is a diagram for explaining a relation between twist of the liquid crystal molecule and the extinction angle in a case as shown in FIG. 1;

FIG. 17 is a diagram for explaining a relation between twist of the liquid crystal molecule and the extinction angle in a case as shown in FIG. 11;

FIG. 18 is a diagram for explaining a relation between the extinction angle of polarizing plates forming a typical TN-type liquid crystal cell and an optical rotation angle of the liquid crystal in a conventional spatial-light-intensity modulation element; and

FIG. 19 is a diagram for explaining a relation between the transmittance of light transmitted through the liquid crystal cell and voltage applied on the liquid crystal cell in the conventional spatial-light-intensity modulation element.

### DETAILED DESCRIPTION OF THE PREFERRED EMBODIMENTS

Exemplary embodiments of an optical element and an optical information recording/reproducing apparatus according to the present invention are described in detail below with reference to the accompanying drawings. The present invention is not limited to these exemplary embodiments. A term of “approximately” described with angles means that the angle includes a margin plus or minus approximately 5 degrees.

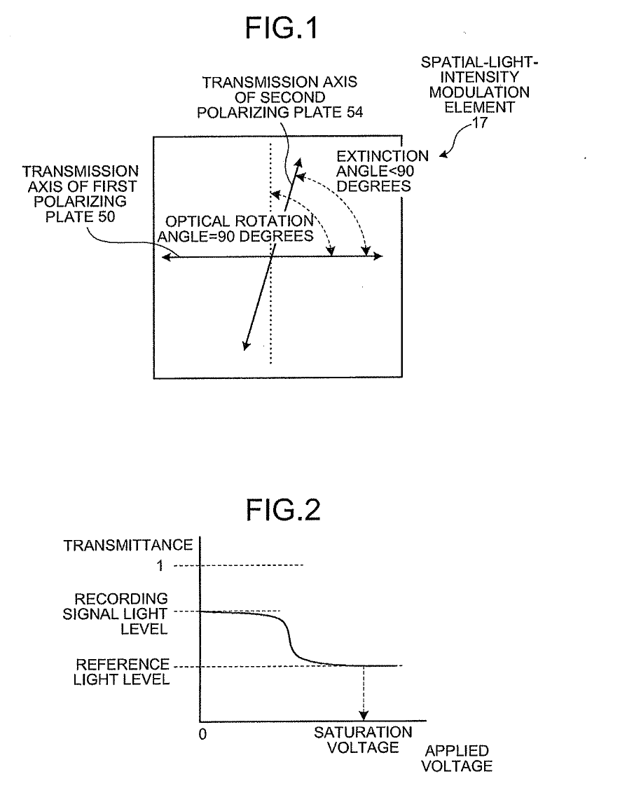

First, features of a spatial-light-intensity modulation element according to a first embodiment are described. FIG. 1 is a diagram for explaining the features of a spatial-light-intensity modulation element 17 according to the first embodiment. FIG. 2 is a diagram for explaining a relation between light transmittance and voltage applied on a liquid crystal in the spatial-light-intensity modulation element 17 according to the first embodiment.

The spatial-light-intensity modulation element 17 is similar to the conventional TN-type liquid crystal element in which a liquid crystal layer is arranged between two polarizing plates, that is, a first polarizing plate 50 and a second polarizing plate 54, and light intensity modulation is performed by controlling the light transmittance using the optical activity due to the spiral-structured liquid crystal.

However, the spatial-light-intensity modulation element 17 according to the first embodiment is dissimilar to the conventional TN-type liquid crystal element in which the extinction angle, which is an angle formed by light transmission axis of the first polarizing plate 50 and the second polarizing plate 54, is set to an angle smaller than 90 degrees as shown in FIG. 1. The optical rotation angle, which is an angle through which light rotates due to the optical activity of the spiral-structured liquid crystal, is set to approximately 90 degrees

By using the extinction angle and the optical rotation angle having the values described above, it is possible to obtain, as shown in FIG. 2, the recording signal light and the reference light having predetermined intensity levels by applying no voltage or a saturation voltage at which the liquid crystal molecule is arranged in a direction approximately orthogonal to the first polarizing plate 50 and the second polarizing plate 54 so that light transmittance is saturated, to the liquid crystal.

Specifically, when the saturation voltage is applied, the optical activity of the liquid crystal disappears and the transmittance falls to a predetermined transmittance level but not 0 because the transmission axes of the two polarizing plates are not orthogonal to each other. When no voltage is applied, light is transmitted though the transmittance falls, because the transmission axes of the first polarizing plate 50 and the second polarizing plate 54 are not orthogonal to each other, by a certain amount subjected to the optical activity of the liquid molecules.

As described above, by setting the extinction angle to approximately 90 degrees, the optical rotation angle to smaller than 90 degrees, and the applied voltage to either the saturation voltage or 0, it is possible to facilitate setting of the transmittance to the predetermined reference light level and the predetermined recording signal light level. If the extinction angle is set to, for example, a value in a range from approximately 40 degrees to approximately 60 degrees, it is possible to generate the recording signal light and the reference light having the intensity levels appropriate for recording information on the recording medium. This makes it possible to obtain a stable control over the intensity levels of the recording signal light and the reference light with the simple structure thereby improving the response speed for generating the recording signal light and the reference light.

Although the saturation voltage is applied to the liquid crystal to generate the reference light, it is allowable to apply a voltage larger than the saturation voltage. The intensity-level ratio between the recording signal light and the reference light can be set to a predetermined ratio such as 2:1 by adjusting the extinction angle.

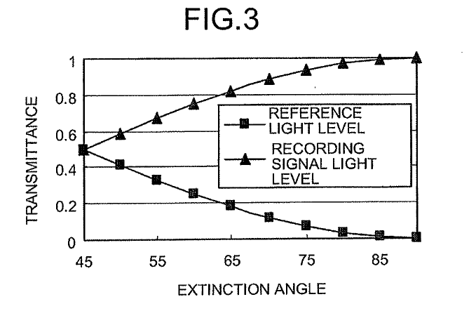

FIG. 3 is a diagram for explaining a relation between the light transmittance and the extinction angle. As shown in FIG. 3, the reference light level is the light transmittance level in the case the saturation voltage is applied to the liquid crystal, while the recording signal light level is the light transmittance level in the case no voltage is applied to the liquid crystal.

To set the intensity-level ratio between the recording signal light and the reference light to, for example, 2:1, the extinction angle is set to approximately 55 degrees so that a transmittance ratio between the recording signal light and the reference light is set to 2:1. Thus, the intensity levels of the recording signal light and the reference light can be set to an arbitrary ratio by using the relation shown in FIG. 3.

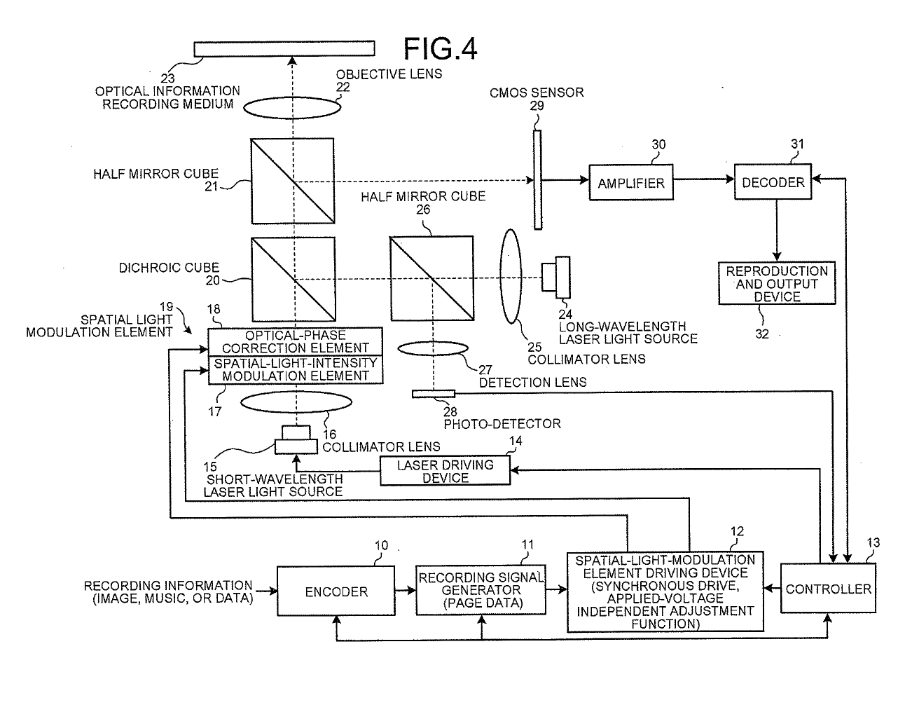

Then, the structure of an optical information recording/reproducing apparatus according to the first embodiment is described. FIG. 4 is a diagram for explaining the structure of the optical information recording/reproducing apparatus according to the first embodiment. As shown in FIG. 4, the optical information recording/reproducing apparatus includes an encoder 10, a recording signal generator 11, a spatial-light-modulation element driving device 12, a controller 13, a laser driving device 14, a short-wavelength laser light source 15, a collimator lens 16, a spatial light modulation element 19 that is formed with the spatial-light-intensity modulation element 17 and an optical-phase correction element 18, a dichroic cube 20, a half mirror cube 21, an objective lens 22, a long-wavelength laser light source 24, a collimator lens 25, a half mirror cube 26, a detection lens 27, a photo-detector 28, a CMOS (Complementary Metal Oxide Semiconductor) sensor 29, an amplifier 30, a decoder 31, and a reproduction and output device 32.

The short-wavelength laser light source 15 emits a light beam having the light intensity adjusted to a value appropriate for recording or reproduction of information. The light intensity adjustment is performed by the laser driving device 14 under control of the controller 13. The light beam emitted from the short-wavelength laser light source 15 is converted into parallel light, which travels in approximately parallel, by the collimator lens 16 and enters the spatial light modulation element 19 that is formed with the spatial-light-intensity modulation element 17 and the optical-phase correction element 18.

The spatial-light-intensity modulation element 17 and the optical-phase correction element 18, as described in details later, are divided into a plurality of segments. The spatial-light-intensity modulation element 17 modulates the light intensity of the light beam by using each of the segments, and the optical-phase correction element 18 corrects the optical-phase difference of the light-intensity modulated light beam by using each of the segments.

The encoder 10 receives an input of recording information (image, music, or data) and encodes the received recording information under control of the controller 13. The recording signal generator 11 converts the recording signal encoded by the encoder 10 into page data, and sequentially sends the page data to the spatial-light-modulation element driving device 12.

The spatial-light-modulation element driving device 12 drives each of the segments of the spatial-light-intensity modulation element 17 and the optical-phase correction element 18 in synchronization with each other by independently applying voltage to each segment, thereby operating the spatial-light-intensity modulation element 17 to modulate the light intensity of the light beam and operating the optical-phase correction element 18 to correct the optical phase of the light beam to generate the recording signal light and the reference light having a common optical axis and a same optical phase.

The recording signal light and the reference light generated by the spatial-light-intensity modulation element 17 and the optical-phase correction element 18 are transmitted through the dichroic cube 20 that reflects long-wavelength laser light, further transmitted through the half mirror cube 21, enter the objective lens 22, and reach a recording layer of an optical information recording medium 23 that records thereon optical information. On the recording layer of the optical information recording medium 23, an interference patter is formed due to diffraction and interference of the converged light beam that has been transmitted through the objective lens 22, and information is recorded.

The long-wavelength laser light emitted from the long-wavelength laser light source 24 is used for controlling a focus direction and a track direction of the objective lens 22. The long-wavelength laser light is used for reproducing address information that is pre-formed as embossed pits on the optical information recording medium 23 that is rotated in its surface by a spindle motor (not shown). Based on the address information, access control for recording or reproducing of information is performed.

Specifically, the long-wavelength laser light emitted from the long-wavelength laser light source 24 is converted into parallel light, which travels in approximately parallel, by the collimator lens 25. The long-wavelength laser light is transmitted through the half mirror cube 26, reflected by the dichroic cube 20, transmitted through the half mirror cube 21, and then enters the objective lens 22.

The objective lens 22 causes the long-wavelength laser light to converge on an address-information recording surface of the optical information recording medium 23. The long-wavelength laser light including servo information such as address information, a track error signal, or a focus error signal is reflected by a reflective layer provided in the optical information recording medium 23, passes through the objective lens 22, the half mirror cube 21, the dichroic cube 20, the half mirror cube 26, and the detection lens 27, and then reaches the photo-detector 28 for detecting information such as the servo information and the address information.

The long-wavelength laser light is converted into an electric signal by the photo-detector 28, and the address information, the track error signal, or the focus error signal is sent to the controller 13. The controller 13 controls a position of the objective lens 22 based on the information received from the photo-detector 28 to cause the light beam to converge on a predetermined area of the optical information recording medium 23.

The interference pattern information that is recorded on the recording layer of the optical information recording medium 23 can be reproduced by causing the recording layer to be exposed with only the reference light. Specifically, when the recording layer is exposed with the reference light for reproducing, the reference light is reflected by the reflective layer of the optical information recording medium 23 while reconstructing wavefront of the recording signal light that is recorded on the recording layer, and then enters the CMOS sensor 29 via the half mirror cube 21.

The CMOS sensor 29 converts the recording signal light reproduced from the recording layer into an electric signal. The electric signal is sent via the amplifier 30 to the decoder 31, decoded by the decoder 31, and reproduced by the reproduction and output device 32.

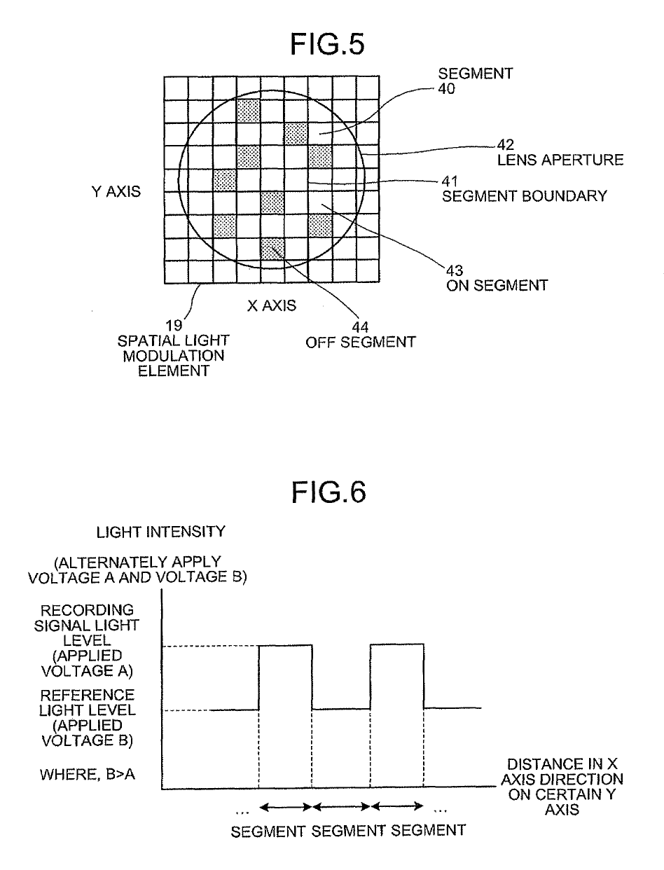

Given below is an explanation of the spatial light modulation element 19 shown in FIG. 4. FIG. 5 is a diagram for explaining the spatial light modulation element 19 shown in FIG. 4. The spatial light modulation element 19 has the structure in which the spatial-light-intensity modulation element 17 and the optical-phase correction element 18 adhere to each other. When a light beam is transmitted through the spatial light modulation element 19, the recording signal light and the reference light are generated.

As shown in FIG. 5, the spatial light modulation element 19 has segments 40 and segment boundaries 44. In FIG. 5, a relation between the spatial light modulation element 19 and a lens aperture 16 of a collimator lens that causes a light beam to converge on the spatial light modulation element 19 is shown.

The respective segments 40 are separated by the segment boundaries 41. The spatial light modulation element 19 is formed of a liquid crystal element or an electric optical element, refractive index anisotropy of which electrically changes. Thus, when a voltage is applied to the respective segments 40, the respective segments 11 change to ON segments 43 in which the intensity of transmitted light is high or OFF segments 44 in which the intensity of transmitted light is low (not 0).

FIG. 6 is a diagram of a modulation state of the light intensity of a light beam transmitted through a plurality of segments 40 of the spatial light modulation element 19 shown in FIG. 5. The concept of the recording signal light and the reference light is explained with reference to FIG. 6.

As shown in the figure, an applied voltage for generating recording signal light is set as A, an applied voltage for generating reference light is set as B (B>A), and the applied voltages A and B are alternately applied to the respective segments 40. According to the present embodiment, recording signal light and reference light are generated in a superimposed state by transmitting a laser beam as a light source through the spatial light modulation element 19.

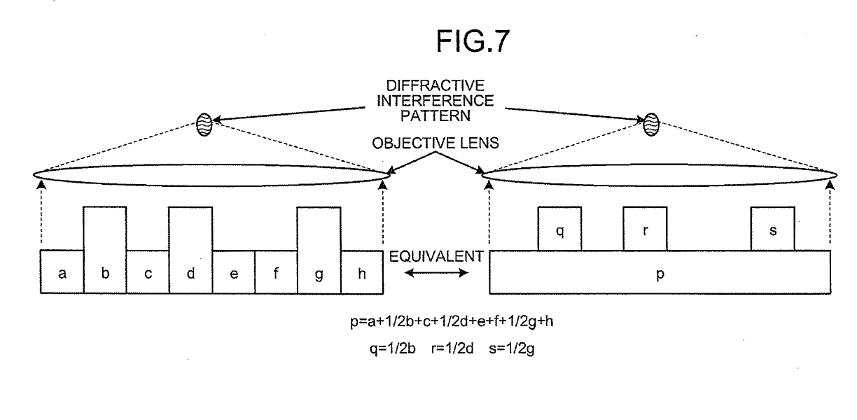

FIG. 7 is a diagram for explaining a principle of optical information recording processing according to the first embodiment. According to a principle explained below, a light beam generated using the spatial light modulation element 19 is reference light over the entire surface of the light beam and changes to recording signal light that can be subjected to light intensity modulation according to recording information over the entire surface. In the recording layer of the optical information recording medium, the light beam is diffracted and interferes near a focus of an objective lens that converges the light beam and a diffractive interference pattern in which the reference light and the recording signal light are three-dimensionally diffracted and interfere with each other is recorded.

FIG. 7 indicates that an interference pattern generated by a light beam (light intensity components a, b, c, d, e, f, g, and h) transmitted through the respective segments 40 is equivalent to a diffractive interference pattern generated from reference light (a light intensity component p) and recording signal light (light intensity components q, r, and s).

In general, strong far-field diffraction occurs in a three-dimensional area near a focus including a focal plane of an objective lens. According to the Babinet's principle, light intensity components of the respective segments 40 of the spatial light modulation element 19 independently subjected to Fourier transform in integration areas of the respective light intensity components and added up are equivalent to light intensity components of all the segments 40 subjected to Fourier transform in all the integration areas. Based on this equality of the light intensity components and linearity in Fourier transform, a diffractive interference pattern in the example in FIG. 7 can be represented as follows:

A diffractive interference pattern

$$\begin{matrix}= F ( a ) + F ( b ) + F ( c ) + F ( d ) + F ( e ) + F ( f ) + F ( g ) + F ( h ) \\ = F ( a ) + F ( 2 q ) + F ( c ) + F ( 2 r ) + F ( e ) + F ( f ) + F ( 2 s ) + F ( h ) \\ = F ( a ) + 2 F ( q ) + F ( c ) + 2 F ( r ) + F ( e ) + F ( f ) + 2 F ( s ) + F ( h ) \\ = F ( a ) + F ( 1 / 2 b ) + F ( q ) + F ( c ) + F ( 1 / 2 d ) + F ( r ) + F ( e ) \\ F ( f ) + f ( i / 2 g ) + F ( s ) + F ( h ) \\ = F ( a ) + F ( 1 / 2 b ) + F ( c ) + F ( 1 / 2 d ) + F ( e ) + F ( f ) + F ( 1 / 2 g ) + \\ F ( h ) + F ( q ) + F ( f ) + F ( s ) .\end{matrix}$$

Here, F(x) indicates Fourier transform of a light intensity component x. For simplicity of explanation,

q=½b,

r=½d, and

s=½g.

When p=a+½b+c+½d+e+f+½g+h, according to the Babinet's principle and the linearity of Fourier transform, F(a)+F(½b)+F(c)+F(½d)+F(e)+F(f)+F(½g)+F(h)=F(p). Thus,

a diffractive interference pattern

$$= F ( p ) + ( F ( q ) + F ( r ) + F ( s ) ) \\ = F ( p ) + F ( q + r + s ) .$$

Because the same diffraction phenomenon appears even when the reference light and the recording signal light are separated in this way, a strong diffractive interference pattern due to the reference light and the recording signal light appears in a three-dimensional space near the focus including the focal plane.

On the other hand, in a section considerably apart from the focus, because a diffraction effect is small and a light density is also small, the intensity of a diffractive interference pattern is extremely weak. The diffractive interference pattern is recorded only near a convergent point according to a relation between the intensity and the sensitivity of a recording material.

Given below is an explanation of the structure of the spatial-light-intensity modulation element 17 and the optical-phase correction element 18 that form the spatial light modulation element 19. The spatial-light-intensity modulation element 17 includes a liquid crystal element of a TN (Twisted Nematic) type. The optical-phase correction element 18 includes a liquid crystal element of a TFT (Thin Film Transistor) type.

In this embodiment, the spatial-light-intensity modulation element 17 and the optical-phase correction element 18 include liquid crystal elements. However, an idea same as that in this embodiment can be applied when electric optical elements are used.

Each of the spatial-light-intensity modulation element 17 and the optical-phase correction element 18 are divided into the respective segments 40 by the segment boundaries 41 as shown in FIG. 5. The respective segments 18 of the spatial-light-intensity modulation element 17 and the optical-phase correction element 21 are arranged to share an area through which a light beam is transmitted.

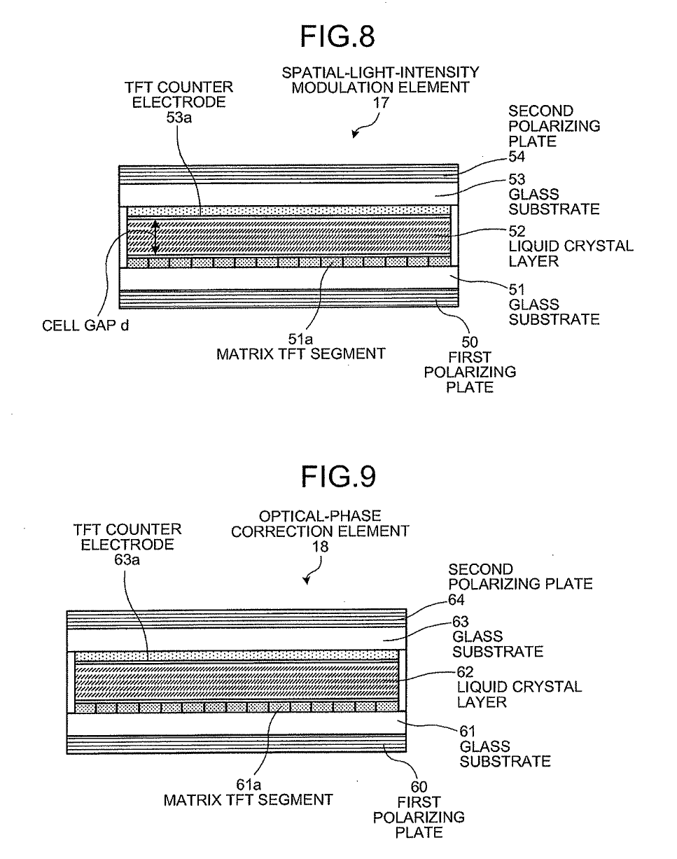

FIG. 8 is a diagram for explaining the structure of the spatial-light-intensity modulation element 17, and FIG. 9 is a diagram for explaining the structure of the optical-phase correction element 18. As shown in FIG. 8, the spatial-light-intensity modulation element 17 includes the first polarizing plate 50, a glass substrate 51, a liquid crystal layer 52, a glass substrate 53, and the second polarizing plate 54.

As described with reference to FIG. 1, the extinction angle formed by the transmission axis of the first polarizing plate 50 and the transmission axis of the second polarizing plate 54 is set to an angle smaller than 90 degrees. The liquid crystal is a TN-type liquid crystal, and the optical rotation angle is set to 90 degrees.

A matrix TFT segment 51a, which is a TFT-driven segment of a matrix shape, is formed on the glass substrate 51. Moreover, inner surfaces of the glass substrate 51 and the glass substrate 53 are subjected to an aligning treatment of rubbing an alignment treating agent such as polyimide on the film.

In the spatial-light-intensity modulation element 17 having such structure, when the matrix segment-based liquid crystal molecules is driven through a TFT drive and the saturation voltage or no voltage is applied, the recording signal light and the reference light having the light intensities show in FIG. 6 are generated efficiently.

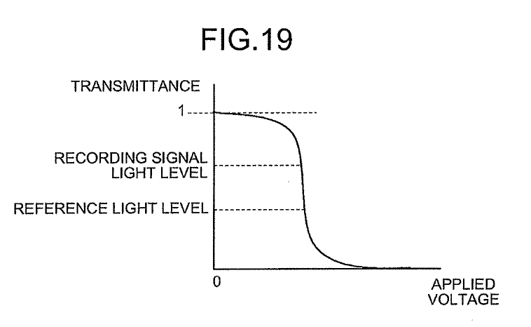

The transmittance control in the conventional spatial-light-intensity modulation element for generating the recording signal light and the reference light is performed by adjusting applied voltage in a range the transmittance changes steeply as shown in FIG. 19 (corresponding to so-called gradient control for liquid-crystal image display). However, the transmittance control in the first embodiment is performed by setting the applied voltage to the saturation voltage or zero, which allows simplifying the control and improving the response characteristic dramatically.

Moreover, as shown in FIG. 6, the recording signal light and the reference light in the present embodiment form two-positional light intensity structure in which the reference light falls on the lower position and the recording signal light falls on the upper position. As a result, contrast between black and white in the spatial-light-intensity modulation element 17 causes no problem. This means that Cell gap d shown in FIG. 8 decreases. Narrower Cell gap d makes it possible to enhance the response speed against the applied voltage.

In a case the spatial-light-intensity modulation element 17 modulates the light intensity of the light beam thereby generating the recording signal light and the reference light, the generated recording signal light and the generated reference light have a different optical phase. To correct the difference, the optical-phase correction element 18 is used.

As shown in FIG. 9, the optical-phase correction element 18 includes a first polarizing plate 60, a glass substrate 61, a liquid crystal layer 62, a glass substrate 63, and a second polarizing plate 64. A polarization state of the light beam transmitted through the TN-type liquid crystal element as the spatial-light-intensity modulation element 17 is linearly-polarized light, and the light transmission axis of the first polarizing plate 60 agrees with the polarization direction of the linearly-polarized light.

Matrix TFT segments 61a that are matrix segments using a TFT drive are formed on the glass substrate 61. The second polarizing plate 64 adheres to the glass substrate 63 such that a direction of the light transmission axis of the second polarizing plate 64 agrees with a direction of the light transmission axis of the first polarizing plate 60.

A TFT counter electrode 63a that is a counter electrode against the matrix TFT segments 61a is formed on the glass substrate 63. Orientation film treatment performed by rubbing an orientation agent such as polyimide is applied to inner side surfaces of the glass substrate 61 and the glass substrate 63. Liquid crystal molecules are oriented to coincide with the transmission axes of the light beam through the first polarizing plate 60 and the second polarizing plate 64.

By TFT-driving the liquid crystal molecules by segment units in a matrix shape using the optical-phase correction element 18 having such a structure, the tilt of the liquid crystal molecules can be controlled in a state in which directions of the liquid crystal molecules are aligned in one direction. According to a relation between the refractive index anisotropy and the optical phase, the optical phase of the light beam transmitted through the optical-phase correction element 18 can be freely adjusted. It is possible to correct the shift of the optical phase caused when the spatial-light-intensity modulation element 17 modulates the light intensity of the light beam.

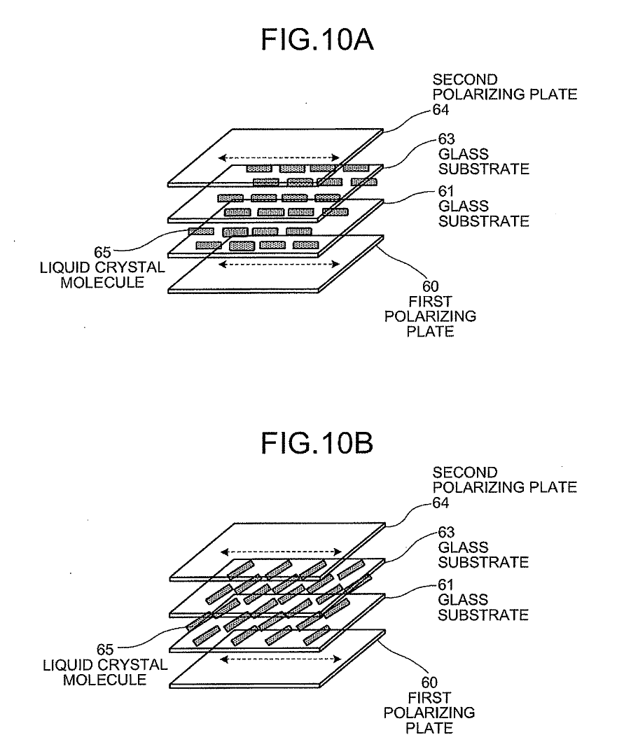

Given below is an explanation of a state of the liquid crystal molecule when the optical-phase correction element 18 is in an OFF state or an ON state. FIG. 10A is a diagram of a state of the liquid crystal molecules at the time when the optical-phase correction element 18 is in an OFF state. FIG. 10B is a diagram of a state of the liquid crystal molecules at the time when the optical-phase correction element 18 is in an ON state.

As shown in FIG. 10A, when the optical-phase correction element 18 is in the OFF state, i.e., a voltage is not applied to the segments of the optical-phase correction element 18, liquid crystal molecules are oriented in a direction determined by the rubbing treatment and the orientation film treatment.

As shown in FIG. 10B, when the optical-phase correction element 18 is in the ON state, i.e., a voltage is applied to the segments of the optical-phase correction element 18, the orientation direction of liquid crystal molecules 65 changes. The refractive index anisotropy thereof changes according to the change in the orientation direction. The shift of the optical phase of the light beam can be corrected by changing the refractive index anisotropy in this way.

The respective segments of the spatial-light-intensity modulation element 17 and the respective segments of the optical-phase correction element 18 are arranged vertically to be associated with each other in a one to one relation. To perform light intensity modulation according to recording information, in synchronization with the respective segments of the spatial-light-intensity modulation element 17 being brought in to the ON or OFF state, the segments of the optical-phase correction element 18 corresponding to the respective segments of the spatial-light-intensity modulation element 17 are brought into the ON or OFF state. The optical phase of the light beam transmitted through the optical-phase correction element 18 is controlled to be fixed over the entire surface of thereof.

As a specific method of correcting an optical phase, for example, there are a method of driving only the segments of the optical-phase correction element 18 corresponding to the segments of the spatial-light-intensity modulation element 17 brought into the ON state and matching an optical phase of recording signal light to an optical phase of reference light and a method of setting an optical phase at a maximum or minimum transmittance level of the spatial-light-intensity modulation element 17 as a reference and matching optical phases of recording signal light and reference signal light to the optical phase.

As described above, in the first embodiment, the spatial-light-intensity modulation element 17 includes the first polarizing plate 50, the second polarizing plate 54, and the liquid crystal layer 52 arranged between the first polarizing plate 50 and the second polarizing plate 54, and the extinction angle, which is an angle formed by the light transmission axis of the first polarizing plate 50 and the light transmission axis of the second polarizing plate 54 is set to an angle smaller than 90 degrees. When the orientation state of the liquid crystal changes depending on the applied voltage that is no voltage or the saturation voltage at which light transmittance is saturated or larger, the recording signal light and the reference light having a predetermined light-intensity ratio are generated. This makes it possible to obtain a stable control over the intensity levels of the recording signal light and the reference light thereby improving the response speed for generating the recording signal light and the reference light.

Moreover, in the first embodiment, the optical rotation angle, through which the light transmitted through the liquid crystal layer 52 rotates, does not agree with the extinction angle. This makes it possible to set the intensity level of the recording signal light and the intensity level of the reference light to arbitrary levels.

Furthermore, in the first embodiment, the extinction angle is set to an angle smaller than 90 degrees while the optical rotation angle is approximately 90 degrees, which allows efficiently generating the recording signal light and the reference light having arbitrary intensity levels.

Moreover, in the first embodiment, the extinction angle is set to an angle in a range from approximately 40 degrees to approximately 60 degrees. This allows generating the recording signal light and the reference light having the intensity levels appropriate for recording information on a recording medium.

Furthermore, in the first embodiment, the extinction angle is set to approximately 55 degrees, which allows setting a ratio between the light intensity of the recording signal light and the light intensity of the reference light to a proper value such as approximately 2:1.

Moreover, in the first embodiment, the spatial-light-intensity modulation element 17 includes the first polarizing plate 50, the second polarizing plate 54 that is arranged such that the extinction angle, which is an angle formed by the light transmission axis of the first polarizing plate 50 and its own light transmission axis, is smaller than 90 degrees, and the liquid crystal layer 52 that is arranged between the first polarizing plate 50 and the second polarizing plate 54. The liquid crystal layer 52 generates the recording signal light and the reference light through segment-based light transmittance control that is obtained by changing an orientation state of liquid crystal corresponding to each of segments. This makes it possible to efficiently generate the recording signal light and the reference light by using smaller area.

Furthermore, in the first embodiment, the spatial-light-intensity modulation element 17 that generates, for recording optical information on the optical information recording medium 23 through volumetric recording, light with which the optical information recording medium 23 is to be exposed, that is, the recording signal light including predetermined information and the reference light for interfering with the recording signal light by changing an orientation state of a liquid crystal includes the liquid crystal layer 52 that generates the recording signal light and the reference light having a predetermined light-intensity ratio through change of the orientation state of the liquid crystal to which any one of the saturation voltage, at which the light transmittance is saturated, or larger and no voltage is applied. This makes it possible to obtain a stable control over the intensity levels of the recording signal light and the reference light thereby improving the response speed for generating the recording signal light and the reference light.

The extinction angle is set to a value smaller than 90 degrees and the optical rotation angle is set to 90 degrees in the first embodiment so that the maximum light transmittance becomes smaller than 1 and the intensity of the recording signal light becomes weaker. It is allowable to configure the spatial-light-intensity modulation element 17 capable of outputting light having the light transmittance of 1. In a second embodiment, the spatial-light-intensity modulation element 17 capable of outputting light having the light transmittance of 1 is explained.

The structure other than the spatial-light-intensity modulation element 17 is the same as the structure shown in FIG. 4, and the explanation is omitted. Parts corresponding to those in the first embodiment are denoted with the same reference numerals.

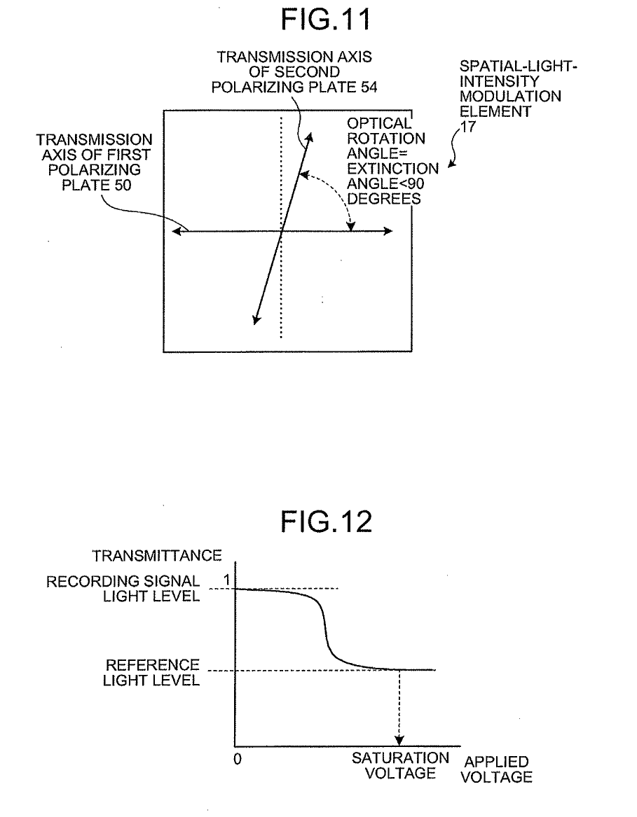

FIG. 11 is a diagram for explaining features of the spatial-light-intensity modulation element 17 according to the second embodiment. FIG. 12 is a diagram for explaining a relation between light transmittance and voltage applied on a liquid crystal in the spatial-light-intensity modulation element 17 according to the second embodiment.

As shown in FIG. 11, in the spatial-light-intensity modulation element 17, the extinction angle, which is an angle formed by the light transmission axes of the first polarizing plate 50 and the second polarizing plate 54, and the optical rotation angle agrees with each other at smaller than 90 degrees. The optical rotation angle is adjusted to agree with the extinction angle through a treatment for liquid crystal alignment.

In a case of the extinction angle and the optical rotation angle are set as described above, when any one of the saturation voltage, at which the liquid crystal molecules are aligned approximately orthogonal to the first polarizing plate 50 and the second polarizing plate 54 and the light transmittance is saturated, or larger and zero voltage is applied to the liquid crystal, the light transmittance for generating the recording signal light can be approximately 1 while allowing setting the intensity levels of the recording signal light and the reference light to predetermined values.

In actual cases, the light transmittance cannot be 1 even in the case the saturation voltage is applied to the liquid crystal because a portion of the light is absorbed into the first polarizing plate 50 and the second polarizing plate 54 or reflected by interfaces of the first polarizing plate 50 and the second polarizing plate 54. The transmittance is decided to indicate 1 when excluding such light losses.

To set the intensity-level ratio between the recording signal light and the reference light to 2:1, the extinction angle and the optical rotation angle is required to be approximately 45 degrees according to the graph shown in FIG. 3. In this case, because the extinction angle and the optical rotation angle agree with each other, when zero voltage is applied, the transmittance of the reference light level becomes 1 regardless of the extinction angle. When the saturation voltage is applied, the transmittance of the reference light level becomes 0.5. Thus, the intensity-level ratio of the recording signal light and the reference light can be set to 2:1.

As described above, in the second embodiment, the extinction angle and the optical rotation angle agree with each other. Therefore, when zero voltage is applied to the liquid crystal, the transmittance becomes approximately 1, thus increasing the light intensity of the recording signal light.

Moreover, in the second embodiment, the extinction angle and the optical rotation angle are set to approximately 45 degrees. This allows setting a ratio between the light intensity of the recording signal light and the light intensity of the reference light to a proper value such as approximately 2:1.

In the first and the second embodiments, when zero voltage is applied, the recording signal light is generated, and when the saturation voltage is applied, the reference light is generated. It is allowable that when the saturation voltage is applied, the recording signal light is generated, and when zero voltage is applied, the reference light is generated. Given below is an explanation of the spatial-light-intensity modulation element 17 according to a third embodiment in which when the saturation voltage is applied, the recording signal light is generated, and when zero voltage is applied, the reference light is generated.

The structure other than the spatial-light-intensity modulation element 17 is the same as the structure shown in FIG. 4 in the third embodiment, and the explanation is omitted. Parts corresponding to those in the first embodiment are denoted with the same reference numerals.

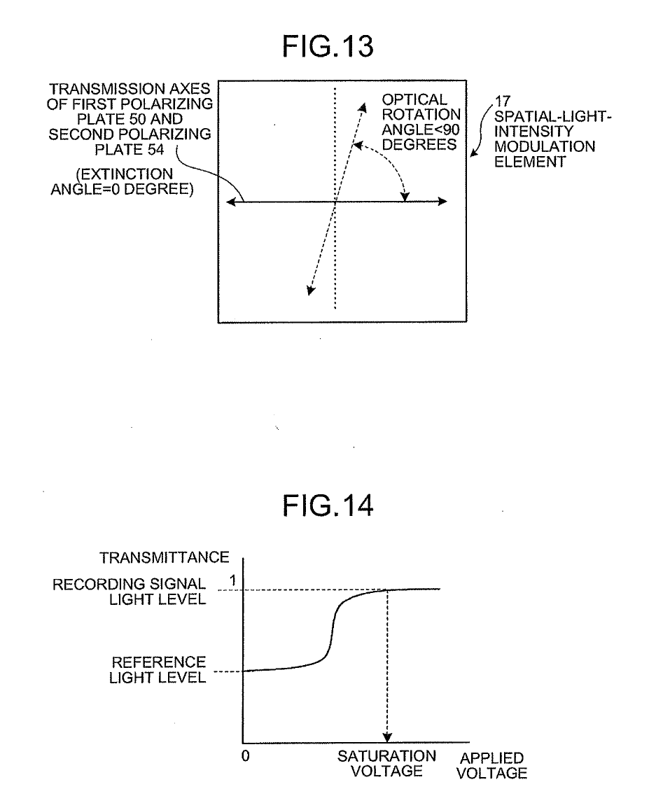

Features of the spatial-light-intensity modulation element 17 according to the third embodiment are described. FIG. 13 is a diagram for explaining features of the spatial-light-intensity modulation element 17 according to the third embodiment. FIG. 14 is a diagram for explaining a relation between light transmittance and voltage applied on the liquid crystal in the spatial-light-intensity modulation element 17 according to the third embodiment.

As shown in FIG. 13, the spatial-light-intensity modulation element 17 is dissimilar to the spatial-light-intensity modulation element 17 according to the first and the second embodiments in which the transmission axis of the first polarizing plate 50 and the transmission axis of the second polarizing plate 54 are arranged not orthogonal to each other but parallel to each other. It means that the extinction angle, which is an angle formed by the transmission axis of the first polarizing plate 50 and the transmission axis of the second polarizing plate 54, is set to 0 degree.

In a case that the liquid crystal is subjected to the aligning treatment for, for example, forcing a light beam to rotate through 90 degrees with respect to the direction of the transmission axis of the first polarizing plate 50, when zero voltage is applied, the transmittance becomes 0, and when the saturation voltage, at which the transmittance is saturated, is applied, the transmittance becomes 1.

In another case that the liquid crystal is subjected to the aligning treatment for forcing a light beam to rotate through approximately 45 degrees, as shown in FIG. 14, when zero voltage is applied, the transmittance becomes 0.5 (see, FIG. 3), and when the saturation voltage is applied, the transmittance becomes 1. As a result, the intensity-level ratio between the recording signal light and the reference light is set to 2:1. This facilitates generating the recording signal when the saturation voltage is applied and the reference light when zero voltage is applied.

As described above, in the third embodiment, the light transmission axis of the first polarizing plate 50 and the light transmission axis of the second polarizing plate 54 are parallel to each other (the extinction angle is 0 degree), and the liquid crystal layer 52 has optical activity for forcing transmitted light to rotate. When the orientation state of the liquid crystal changes depending on the applied voltage that is no voltage or the saturation voltage at which light transmittance is saturated or larger, the recording signal light and the reference light having a predetermined light-intensity ratio are generated. This makes it possible to obtain a stable control over the intensity levels of the recording signal light and the reference light thereby improving the response speed for generating the recording signal light and the reference light.

Moreover, in the third embodiment, the light transmission axis of the first polarizing plate 50 and the light transmission axis of the second polarizing plate 54 are parallel to each other and the optical rotation angle, through which light transmitted through the liquid crystal layer 52 rotates, is approximately 45 degrees. This allows setting a ratio between the light intensity of the recording signal light and the light intensity of the reference light to a proper value such as approximately 2:1.

In the first, the second, and the third embodiments, the optical-phase difference between the recording signal light and the reference light generated by the spatial-light-intensity modulation element 17 is corrected using the optical-phase correction element 18. Adjustment of Cell gap d can be replaced with the optical-phase correction element 18. A case of using adjustment of Cell gap d replaced with the optical-phase correction element 18 is explained according to a fourth embodiment.

If there is the optical-phase correction element 18 in the optical information recording/reproducing apparatus, it is difficult to stabilize manufacture processes of the optical information recording/reproducing apparatus and it is required a complicated evaluation process of evaluating whether a proper amount of the optical phase is corrected. If the optical-phase correction element 18 can be excluded, it is possible to reduce the number of manufacture processes and evaluation processes thereby reducing manufacture costs for the optical information recording/reproducing apparatus.

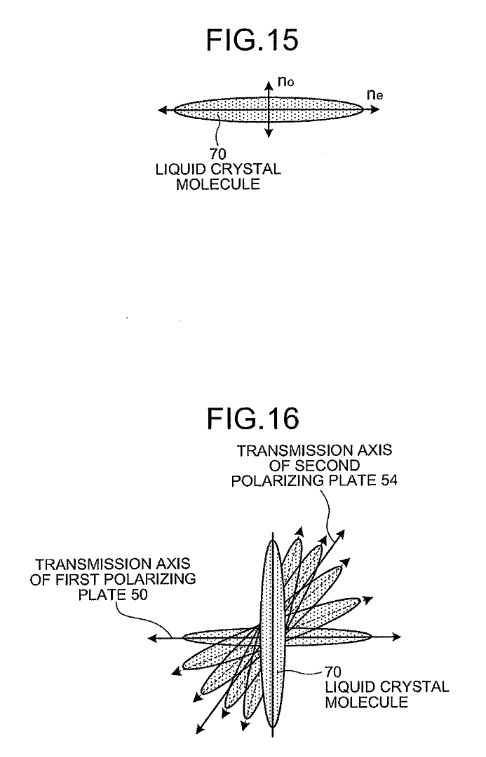

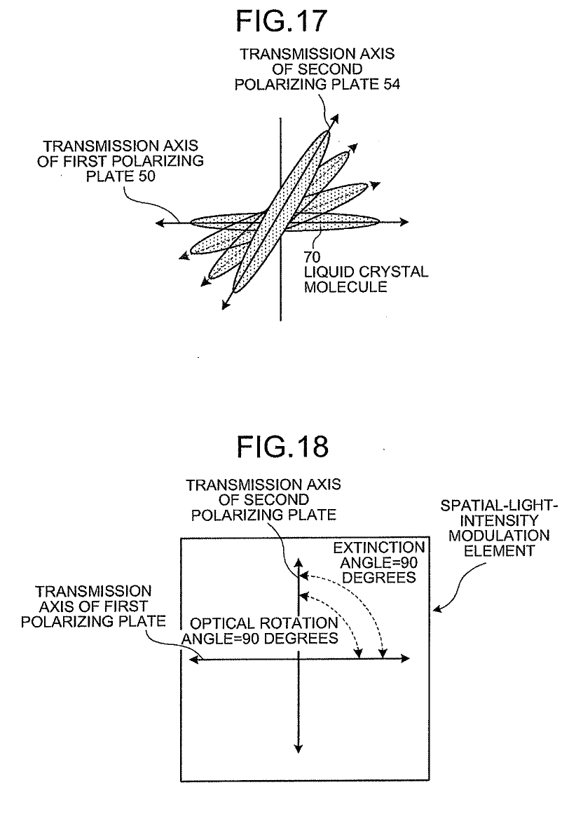

Features of the spatial-light-intensity modulation element 17 according to the fourth embodiment are described below. FIG. 15 is a diagram for explaining anisotropy in the refractive index of a liquid crystal molecule. FIG. 16 is a diagram for explaining a relation between twist of the liquid crystal molecule and the extinction angle in a case as shown in FIG. 1. FIG. 17 is a diagram for explaining a relation between twist of the liquid crystal molecule and the extinction angle in a case as shown in FIG. 11.

As shown in FIG. 15, in the liquid molecule, a refractive index of a long-axis direction is different from that of a short-axis direction. The refractive index of the long-axis direction is represented by nₑ, and the refractive index of the short-axis direction is represented by nₒ.

As shown in FIG. 8 where d indicates the cell gap of the liquid crystal layer 52, the optical-phase difference between the recording signal light and the reference light generated when the light beam is transmitted through the segments of the spatial-light-intensity modulation element 17 corresponds to the optical-phase difference between the recording signal light and the reference light in the state of zero voltage is applied.

In the case as shown in FIG. 16, the linearly-polarized light rotates, as shown by dashed-line arrows, approximately 90 degrees along twist of the long-axis direction of a liquid crystal molecule 70. In the case as shown in FIG. 17, the linearly-polarized light rotates, as shown by dashed-line arrows, through approximately 45 degrees along twist of the long-axis direction of the liquid crystal molecule 70. The case as shown in FIG. 13 is the same other than the transmission axis of the first polarizing plate 50 agrees with the transmission axis of the second polarizing plate 54, and the explanation is omitted.

As shown in FIGS. 16 and 17, when the light beam is transmitted through the segments in the state zero voltage is applied to the segments, the light beam rotates along the twist of the long axis of the liquid crystal molecule 70. When the saturation voltage is applied, there is no twist of the long axis so that the liquid crystal molecule 70 aligns orthogonal to the first polarizing plate 50 and the second polarizing plate 54. It means that the transmitted light is in either one of two states, one is subjected to an influence by an amount of the refractive index of the long-axis direction nₑ of the liquid crystal molecule 70, and the other is subjected to an influence by an amount of the refractive index of the short-axis direction nₒ of the liquid crystal molecule 70.

In this case, Retardation (delay in phase) R between the recording signal light and the reference light is expressed by:

$$\begin{matrix}R = ( {n}_{e} - {n}_{o} ) \cdot d \\ = Δ n \cdot d\end{matrix} \qquad ( 1 )$$

where d indicates the cell gap of the liquid crystal layer 52 shown in FIG. 8, and Δn indicates a difference between the refractive index of the long-axis direction nₑ and the refractive index of the short-axis direction nₒ in the liquid crystal molecule 70.

Retardation R can be conversed into Angle P (radian) by using following Equation 2:

$$\begin{matrix}P = 2 π \cdot R / λ \\ = 2 π \cdot Δ n \cdot d / λ\end{matrix} \qquad ( 2 )$$

where λ indicates a wavelength of the irradiation light.

If it is satisfied a relation as follows:

P=2π·m (m is an integer) (3)

or

d=m·λ/Δn (4)

then,

R=m·λ (5)

Therefore, Retardation R is an integral multiple of Wavelength λ, which indicates a state equivalent to there is no phase difference between the recording signal light and the reference light.

For example, a liquid crystal material having the refractive-index difference Δn of approximately 0.2 is a popular material and it is easy to acquire such liquid crystal material. In this case, Cell gap d can be calculated as follows using Equation 4:

d=5m·λ (6)

Assuming that Retardation R is equivalent to three wavelengths, that is, m=3, Wavelength λ of the light beam is λ=0.4 μm, an extremely practical cell gap value of d=6 μm is obtained. This value is enough for realizing the spatial-light-intensity modulation element 17 according to the fourth embodiment. In actual cases, the liquid crystal molecule 70 has an initial tilt at approximately 2 degrees, which does not make a significant effect on the above calculation though.

As described above, in the fourth embodiment, the liquid crystal layer 52 generates the recording signal light and the reference light having a phase difference of 2 πm (m is an integer) radian, which saves necessity of correcting the optical phase of the generated recording signal light and the generated reference light thereby reducing manufacture costs for the apparatus.

The embodiments of the present invention are described above. Various modifications can be made to the present invention within the scope of the technical ideas disclosed in the claims in addition to the above-described embodiments.

Of the processes described in the embodiments, all or part of the processes explained as being performed automatically can be performed manually. Similarly, all or part of the processes explained as being performed manually can be performed automatically by a known method.

The processing procedures, the control procedures, specific names, various data, and information including parameters described in the embodiments or shown in the drawings can be changed as required unless otherwise specified.

The constituent elements of the optical information recording/reproducing apparatus shown in the drawings are merely conceptual, and need not be physically configured as illustrated. The constituent elements, as a whole or in part, can be separated or integrated either functionally or physically based on various types of loads or use conditions.

According to the present invention, an optical element includes a first polarizing element, a second polarizing element, and a liquid crystal layer arranged between the first polarizing element and the second polarizing element, and the extinction angle, which is an angle formed by the light transmission axis of the first polarizing element and the light transmission axis of the second polarizing element is set to an angle smaller than 90 degrees (including 0 degrees, i.e., a case where the light transmission axis of the first polarizing element and the light transmission axis of the second polarizing element are parallel to each other). When the orientation state of the liquid crystal changes depending on the applied voltage that is no voltage or the saturation voltage at which light transmittance is saturated or larger and, recording signal light and reference light each having a predetermined light-intensity ratio are generated. This makes it possible to obtain a stable control over the intensity levels of the recording signal light and the reference light thereby improving the response speed for generating the recording signal light and the reference light.

Moreover, according to the present invention, an optical rotation angle, through which light transmitted through the liquid crystal layer rotates, does not agree with the extinction angle. This makes it possible to obtain an effect of setting the intensity level of the recording signal light and the intensity level of the reference light to arbitrary levels.

Furthermore, according to the present invention, the extinction angle is set a value to smaller than 90 degrees while the optical rotation angle is approximately 90 degrees, which allows obtaining an effect of efficiently generating the recording signal light and the reference light having arbitrary intensity levels.

Moreover, according to the present invention, the extinction angle is set to an angle in a range from approximately 40 degrees to approximately 60 degrees. This allows obtaining an effect of generating the recording signal light and the reference light having the intensity levels appropriate for recording information on a recording medium.

Furthermore, according to the present invention, the extinction angle is set to approximately 55 degrees, which allows obtaining an effect of setting a ratio between the light intensity of the recording signal light and the light intensity of the reference light to a proper value such as approximately 2:1.

Moreover, according to the present invention, the light transmission axis of the first polarizing element and the light transmission axis of the second polarizing element are parallel to each other, and the liquid crystal layer has optical activity to rotate transmitted light. When the orientation state of the liquid crystal changes depending on the applied voltage that is no voltage or the saturation voltage at which light transmittance is saturated or larger, the recording signal light and the reference light having the predetermined light-intensity ratio are generated. This makes it possible to obtain a stable control over the intensity levels of the recording signal light and the reference light thereby improving the response speed for generating the recording signal light and the reference light.

Furthermore, according to the present invention, the light transmission axis of the first polarizing element and the light transmission axis of the second polarizing element are parallel to each other and the optical rotation angle, through which light transmitted through the liquid crystal layer rotates, is approximately 45 degrees. This allows obtaining an effect of setting a ratio between the light intensity of the recording signal light and the light intensity of the reference light to a proper value such as approximately 2:1.

Moreover, according to the present invention, the extinction angle and the optical rotation angle agree with each other. Therefore, when zero voltage is applied to the liquid crystal, the transmittance becomes approximately 1, thus obtaining an effect of increasing the light intensity of the recording signal light.

Furthermore, according to the present invention, in a case of the extinction angle and the optical rotation angle agrees with each other, the extinction angle and the optical rotation angle are set to approximately 45 degrees. This allows obtaining an effect of setting a ratio between the light intensity of the recording signal light and the light intensity of the reference light to a proper value such as approximately 2:1.

Moreover, according to the present invention, the optical element includes the first polarizing element, the second polarizing element that is arranged such that the extinction angle, which is an angle formed by the light transmission axis of the first polarizing element and its own light transmission axis is smaller than 90 degrees, and the liquid crystal layer that is arranged between the first polarizing element and the second polarizing element. The liquid crystal layer generates the recording signal light and the reference light through segment-based light transmittance control that is obtained by changing an orientation state of liquid crystal corresponding to each of segments. This makes it possible to obtain an effect of efficiently generating the recording signal light and the reference light by using smaller area.

Furthermore, according to the present invention, an optical element for generating recording signal light and reference light by changing an orientation state of a liquid crystal to record optical information on a recording medium through volumetric recording, the recording signal light being emitted to the recording medium and including predetermined information, the reference light interfering with the recording signal light, includes a liquid crystal layer that generates the recording signal light and the reference light having a predetermined light-intensity ratio through change of the orientation state of the liquid crystal to which a saturation voltage at which a light transmittance is saturated or larger, or no voltage is applied. This makes it possible to obtain a stable control over the intensity levels of the recording signal light and the reference light thereby improving the response speed for generating the recording signal light and the reference light.

Moreover, according to the present invention, the liquid crystal layer generates the recording signal light and the reference light having a phase difference of 2 πm (m is an integer) radian, which obtains an effect of saving necessity of correcting the optical phase of the generated recording signal light and the generated reference light thereby reducing manufacture costs for the apparatus.

Furthermore, according to the present invention, the optical element further includes a first polarizing element and a second polarizing element between which the liquid crystal layer is arranged, and an extinction angle, which is an angle formed by a light transmission axis of the first polarizing element and a light transmission axis of the second polarizing element, is smaller than 90 degrees. When the orientation state of the liquid crystal changes depending on the applied voltage that is no voltage or the saturation voltage, at which light transmittance is saturated, or larger, the recording signal light and the reference light having the predetermined light-intensity ratio are generated. This makes it possible to obtain a stable control over the intensity levels of the recording signal light and the reference light thereby improving the response speed for generating the recording signal light and the reference light.

Moreover, according to the present invention, in a case of generating the recording signal light and the reference light through change of the orientation state of the liquid crystal to which the saturation voltage at which the light transmittance is saturated or larger, or no voltage is applied, the extinction angle and an optical rotation angle, through which light transmitted through the liquid crystal layer rotates, agree with each other. Therefore, when zero voltage is applied to the liquid crystal, the transmittance becomes 1, thus obtaining an effect of increasing the light intensity of the recording signal light.

Furthermore, according to the present invention, in a case of generating the recording signal light and the reference light through change of the orientation state of the liquid crystal to which the saturation voltage, at which the light transmittance is saturated or larger, or no voltage is applied, the extinction angle and the optical rotation angle are set to approximately 45 degrees. This makes it possible to obtain an effect of setting the ratio between the light intensity of the recording signal light and the light intensity of the reference light to a proper value such as approximately 2:1.

Moreover, according to the present invention, in a case of generating the recording signal light and the reference light having the predetermined light-intensity ratio through change of the orientation state of the liquid crystal to which the saturation voltage, at which the light transmittance is saturated or larger, or no voltage is applied, the recording signal light and the reference light are generated through segment-based light transmittance control that is obtained by changing an orientation state of liquid crystal corresponding to each of segments. This makes it possible to obtain an effect of efficiently generating the recording signal light and the reference light by using smaller area.

Furthermore, according to the present invention, the liquid crystal layer generates the recording signal light and the reference light using segment-based light transmittances that are set to a first transmittance or a second transmittance. This makes it possible to obtain an effect of efficiently generating the recording signal light and the reference light having the predetermined light-intensity ratio.

Moreover, according to the present invention, an optical information recording/reproducing apparatus that records optical information on a recording medium through volumetric recording and reproduces the optical information from the recording medium includes an optical element that generates recording signal light and reference light having a predetermined light-intensity ratio through change of an orientation state of a liquid crystal to which a saturation voltage, at which a light transmittance is saturated or larger, or no voltage is applied. This makes it possible to obtain a stable control over the intensity levels of the recording signal light and the reference light thereby improving the response speed for generating the recording signal light and the reference light.

Furthermore, according to the present invention, the optical element generates the recording signal light and the reference light having a phase difference of 2 πm (m is an integer) radian, which obtains an effect of saving necessity of correcting the optical phase of the generated recording signal light and the generated reference light thereby reducing manufacture costs for the apparatus.

Moreover, according to the present invention, an optical information recording/reproducing apparatus that records optical information on a recording medium through volumetric recording and reproduces the optical information from the recording medium includes an optical element in which an extinction angle, which is an angle formed by a transmission axis of a first polarizing element and a transmission axis of a second polarizing element the first and the second polarizing elements being opposed to each other across a liquid crystal layer, is set to an angle smaller than 90 degrees. When an orientation state of the liquid crystal changes depending on applied voltage that is no voltage or a saturation voltage at which light transmittance is saturated or larger, recording signal light and reference light having a predetermined light-intensity ratio are generated. This makes it possible to obtain a stable control over the intensity levels of the recording signal light and the reference light thereby improving the response speed for generating the recording signal light and the reference light.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical element for generating recording signal light and reference light by changing an orientation state of a liquid crystal to record optical information on a recording medium through volumetric recording, the recording signal light being emitted to the recording medium and including predetermined information, the reference light interfering with the recording signal light, the optical element comprising:
a first polarizing element;
a second polarizing element; and
a liquid crystal layer that is arranged between the first polarizing layer and the second polarizing layer, wherein
an extinction angle of less than 90 degrees is formed by a light transmission axis of the first polarizing element and a light transmission axis of the second polarizing element.

2. The optical element according to claim 1, wherein an optical rotation angle through which light transmitted trough the liquid crystal layer rotates does not agree with the extinction angle.

3. The optical element according to claim 2, wherein the optical rotation angle is approximately 90 degrees.

4. The optical element according to claim 3, wherein the extinction angle is in a range from approximately 40 degrees to approximately 60 degrees.

5. The optical element according to claim 4, wherein the extinction angle is approximately 55 degrees.

6. The optical element according to claim 1, wherein
the light transmission axis of the first polarizing element is parallel to the light transmission axis of the second polarizing element, and
the liquid crystal layer has optical activity to rotate transmitted light.

7. The optical element according to claim 6, wherein an optical rotation angle through which light transmitted through the liquid crystal layer rotates is approximately 45 degrees.

8. The optical element according to claim 1, wherein the extinction angle and an optical rotation angle through which light transmitted trough the liquid crystal layer rotates agree with each other.

9. The optical element according to claim 8, wherein each of the extinction angle and the optical rotation angle is approximately 45 degrees.

10. The optical element according to claim 1, wherein the liquid crystal layer generates the recording signal light and the reference light under segment-based light transmittance control that changes an orientation state of a liquid crystal for each of a plurality of segments.

11. An optical element for generating recording signal light and reference light by changing an orientation state of a liquid crystal to record optical information on a recording medium through volumetric recording, the recording signal light being emitted to the recording medium and including predetermined information, the reference light interfering with the recording signal light, the optical element comprising:
a liquid crystal layer whose liquid crystal is applied with no voltage or a saturation voltage at which a light transmittance is saturated, to change the orientation state of the liquid crystal and thus to generate the recording signal light and the reference light each having a predetermined light-intensity ratio.

12. The optical element according to claim 11, wherein the liquid crystal layer generates the recording signal light and the reference light each having a phase difference of 2 πm (where m is an integer) radian.

13. The optical element according to claim 12, further comprising a first polarizing element and a second polarizing element that are arranged so that the liquid crystal layer is placed therebetween, wherein
an extinction angle of less than 90 degrees is formed by a light transmission axis of the first polarizing element and a light transmission axis of the second polarizing element.

14. The optical element according to claim 13, wherein the extinction angle and an optical rotation angle through which light transmitted through the liquid crystal layer rotates agree with each other.

15. The optical element according to claim 14, wherein each of the extinction angle and the optical rotation angle is approximately 45 degrees.

16. The optical element according to claim 11, wherein the liquid crystal layer generates the recording signal light and the reference light under segment-based light transmittance control that changes an orientation state of a liquid crystal for each of a plurality of segments.

17. The optical element according to claim 16, wherein the liquid crystal layer generates the recording signal light and the reference light using segment-based light transmittances that are set to a first transmittance or a second transmittance.

18. An optical information recording/reproducing apparatus for recording optical information on a recording medium through volumetric recording and reproducing the optical information from the recording medium, the optical information recording/reproducing apparatus comprising an optical element in which a liquid crystal is applied with no voltage or a saturation voltage at which a light transmittance is saturated to change the orientation state of the liquid crystal and thus to generate the recording signal light and the reference light each having a predetermined light-intensity ratio.

19. The optical information recording/reproducing apparatus according to claim 18, wherein the optical element generates the recording signal light and the reference light having a phase difference of 2 πm (m is an integer) radian therebetween.

20. An optical information recording/reproducing apparatus for recording optical information on a recording medium through volumetric recording and reproducing the optical information from the recording medium, the optical information recording/reproducing apparatus comprising an optical element in which an extinction angle, which is formed by a light transmission axis of a first polarizing element and a light transmission axis of a second polarizing element the first and the second polarizing elements being opposed to each other across a liquid crystal layer, is set to an angle less than 90 degrees.
